(19) United States
(12) Patent Application Publication
(10) Pub. No.: US 2024/0039430 A1
(43) Pub. Date: Feb. 1, 2024

(54) OMNI-ELECTRIC GENERATOR

(71) Applicant: Maahnchooh Mundingo Donald Ghogomu, Lexington Park, MD (US)

(72) Inventor: Maahnchooh Mundingo Donald Ghogomu, Lexington Park, MD (US)

(21) Appl. No.: 18/329,075

(22) Filed: Jun. 5, 2023

Related U.S. Application Data
(60) Provisional application No. 63/477,337, filed on Dec. 27, 2022.

(51) Int. Cl. H02N 11/00

(52) U.S. Cl. CPC H02N 11/002; H02N 11/006

(57) ABSTRACT

This is an electro-mechanical device systematically coupled for complete green energy generation for both AC and DC systems. This self-generating and self-charging Homeostatic Continuous-Flow generator is able to provide uninterrupted energy to power a load and also replenish itself without any external energy/power feed/source. An initial/cranking battery powers a controlled motor engine attached with a dynamo/magneto to mechanically generate boosted current which feeds the load and re-feeds itself. For safety, a battery management system for power/energy control is incorporated. For vehicles, the DC system is connected to the vehicle's accelerator/throttle, the speed control systems and the generator's dynamo/magneto, generating an output that powers the entire vehicle's electrical system interwoven. For home use generator and other applications, the simple DC motor-engine is attached with magneto/dynamo and connected with a Pulse Width Modulation (PWM) Motor Control System which controls speed of the magneto/dynamo to power the entire electrical system via a booster/converter/Inverter.

This Non-Provisional Utility Patent Application claims benefit under Title 35 U.S.C. 119(e)(1), (pre-AIA), (FITF) and references prior Provisional Utility Applications with Application No. 63/477,337 and filing Dates of; 2022 Dec. 27 and 2023 Jun. 1, with Confirmation Number: 8242. This Application also makes reference to the Foreign Filling License Granted on: Jan. 26, 2023, U.S. 63/477,337; Title 35, United States Code, Section 184; Title 37 CFR; 5.11 & 5.15.

Other related invention titled; Aircraft Engine Protection Unit Screen [A.E.P.U] published in 2009.

The [All-Electric Generator] called the “Omni-Electric Generator” is a piece of Green Energy Technology that revolutionizes energy consumption globally, making it universal and affordable.

### INTRODUCTION

My Invention is an electro-mechanical structure of electrical motors, systematically coupled for complete energy cycling; production, transformation, conservation, and distribution around electrical and mechanical structures carefully integrated for self-consumption/self-charging, re-charging and powering processes of its internal structural system on one part, and also the distribution of power to external structures/load on the other part at the same time. It is a unique functioning process integrating sub-systems. These sub-systems include dynamo/magneto/alternator and simple electric motors. Briefly, {a dynamo is a specially designed electric motor with a winding wiring armature on a permanent magnet rotor (including primary and secondary windings in the same direction), stator, cam-type circuit breaker, a parallel connected capacitor, etc.,}. When mechanical force is applied, the rotor spins around its axis converting the mechanical energy to electrical energy. The electromagnetism and electromagnetic force produced, through the simple electric motor with worn wirings on temporary or permanent magnetized armatures converts electromagnetic energy to mechanical energy during the process of induced electro-magnetism. Note: The Alternator Generator (Generates Alternating Current—AC) Recharges the Battery, and this converts/transforms the (AC) power to (DC) from this system, which then powers a load. However, the AC's power potential is limited and weak. The Magneto/Dynamo Generator (Generates Direct Current—DC), which directly powers the Load, and/or recharges the battery when needed as a back-up). The Direct Current (DC) produced by the Magneto can directly power the Dynamo (when applicable), or directly power the Load, and recharge the battery at a faster rate simultaneously. The Dynamo when singly applicable can directly power load with (DC).

### DESCRIPTION: STRUCTURE/CONSTRUCTION

### Section I

The structural arrangement of the electrical motors (dynamo and magneto included) and sub-systems are connected in parallel and/or in series mechanically using components such as joint motor coupling(s), rod(s) or chain(s)/belt(s) to rotate the shaft/freewheel of the dynamo/magneto armature and the electric motor armature. These sub-systems integrate a duo or a trio sub-system of electric motors. These mechanical and electromagnetic motors are synchronized in a structural operational sequence(s) functioning to generate electrical power without the use of external energy source(s). Electrical wires are attached from the dynamo converting the mechanical energy to electrical energy/power which is captured and controlled by use of current fuses, diodes, and voltage electrical components wired in series or parallel to capacitor(s) or battery. The battery/capacitor converts the energy and releases it into the mechanical structure during operation, thus charging the main capacitor/battery system, and re-charging the other sub-systems (powering the electric motor, and the starter battery or power system for operation). The application of this complete re-cycled energy, and self-recharging process is unique within the same mechanical structure. Note: Battery/Capacitor in Parallel Connection maximizes the Voltage Output; and Battery/Capacitor Connection in Series maximizes the Current (Power) Output.

### DESCRIPTION: STRUCTURE/CONSTRUCTION

### Section II

The structural arrangement and sequence of operation is similar to Part I; however, the Battery is used to excite the (electrical motor—alternator or magneto). The alternator attached with the dynamo then connects to the load, the dynamo supplying the electrical power (electricity) required to power the load. However, when a magneto generator is used, it will generate DC current which directly powers the load and also, it recharges the battery at a faster rate, and the battery then powers the load. The magneto can act as a back-up to supply energy to the battery. The magneto can start with or without the use of a battery. However, cranking up the magneto/alternator using a battery is a preferred method for efficiency and convenience. The use of a speed control mechanism controls the speed/rpm of the spinning armature. This electric motor speed control mechanism is applicable in both systems. The battery rate of charge and power/energy output is directly dependent upon the speed/rpm of the spinning rotor (armature).

The successful application of this system is suitable for both domestic and commercial purposes. This includes but not limited to stationed operational devices and moving machines (vehicles/crafts), which use the energy/electrical power produced within the system and also self-recharging itself continuously and uninterrupted. The descriptions are basic examples of simple and safe applications that can be subsequently improved upon, or modified accordingly with variance(s) to suit the parameter(s), application(s) and consumption needs. However, the basic, or fundamental concept of this innovation and the application of these electrical motors and the continuous re-cycling energy process is maintained. The implementation of this structural electro-mechanical system of energy transformation, its electricity/power production and the innovative self-recharging cycle method is new and fundamental to meet the insatiable global energy demand and needs.

### SPECIFICATION

A. Alternator and Dynamo System. When an alternator is used in the structural system, it is electrically powered with the controlled electric motor integrated with the dynamo. While the alternator is capable of self-generating mechanical energy, a powered and controlled source of the mechanical energy is preferred. The alternator is initially powered by a capacitor/battery, which is constantly re-charged in a complete electrical circuit integrated with the dynamo system. The dynamo powers the entire mechanical structure and load in a complete energy re-cycling process, while recharging the battery. The battery used to crank the alternator and which powers the controlled electric motor can either be charged by the alternating current (AC) which is converted to direct current (DC), or otherwise the battery can be directly charged by the dynamo (DC) current. In situations which AC is converted to DC (transformer is required), DC to DC (a converter is required), and DC to AC (an inverter is required). However, DC power is preferred to AC power. AC is weak current, which requires a larger production, transformation, and a longer charging period. DC is direct production and powerful current which has a faster and stronger charging potential.

### BRIEF DESCRIPTION (ALTERNATOR AND DYNAMO) SYSTEM

The electrical energy stored in the battery starts the process by powering the controlled electric motor.
The electrically controlled motor is attached to the alternator and then integrated with the dynamo electric motor.
The dynamo is connected to the Load (electricity flow). For safety and efficient operation, a Direct Current (DC) voltage converter and fuse are applicable for controlled electrical power/energy operations with specific needs to the Load capacity.
The dynamo in the circuit though connected to the load, can at the same time be also directly connected to the battery. Thus, recharging it for continuous operation.
A continuous flow of Mechanical Energy to Electrical Energy conversion and back from Electrical to Mechanical Energy conversion (back and forth or in perpetuity), is maintained, controlled, sustained, and distributed.
Note: The applicability of the wiring system, battery/capacitor, (DC) voltage converter, fuse, and type of mechanical and electrical motors including (dynamo/magneto) used are all dependent upon the parameter(s) of the energy need, and/or Load Capacity. A transformer is applicable when an alternating current is used in the system for Alternating Current (AC) to Direct Current (DC) voltage/power transformation is required.

### SPECIFICATION

B. Magneto/Dynamo System. When a magneto/dynamo is used in the structural set-up, the magneto/dynamo in a separate sub-system is electrically powered by a controlled electric motor integrated with a battery (back-up) system, which is constantly re-charged in a complete electrical circuit integrated with the magneto/dynamo system. In this sub-system, the magneto/dynamo performs three functions; (i) the magneto/dynamo directly powers the load, (ii) the magneto/dynamo directly re-charges the battery which then powers the Load, (if battery circuit is directly routed to the Load), and (iii) the magneto/dynamo re-charges the battery as a back-up power unit while the magneto/dynamo directly powers the entire mechanical structure in a complete energy re-cycling process.

These separate electric motor sub-systems complete the energy cycle and continuously powers itself and any load without any external energy power feed (in other words there is NO use of solar energy or gas/fuel of any type, or wind energy/turbines for power, or of hydro-energy electrical power, or of nuclear energy or of any other external power source of any type. Absolutely NO external energy feeding the generator.

### BRIEF DESCRIPTION (MAGNETO/DYNAMO) SYSTEM

The battery is wired to the electrically controlled motor.
The electrically controlled motor is coupled with the magneto/dynamo.
For safety, a DC voltage booster converter and fuse(s) are applied in the wiring circuit to the Load for the desired controlled power and voltage performance efficiency.
The magneto wiring circuit routed to the battery, supplies electricity, and charges the battery for continuous energy flow powering the entire system, and the magneto circuit directly wired to the Load, powers the Load with electrical energy. That is (Magneto-to-Load).
The magneto directly wired to the main/back-up battery system charges the battery unit, powering the entire circuit. That is the magneto circuit is routed directly to the battery system and the Load (Magneto-to-Battery-to-Load).

### SPECIFICATION:

C. Application with Series of Magnetos and Batteries in Series System: The simultaneous application of multiple electrical motors in same structure to power the dual or multiple magneto systems, and including a series of battery units is based upon the higher or lager energy demand or need for Load Capacity. This application will include but not limited to aircraft, industrial or factory energy, or commercial applications. However, DC energy boosters/step-up converters can be adapted in the system for higher power output, while the batteries/capacitors serve for redundancy purposes.

### BRIEF DESCRIPTION (SERIES OF MAGNETOS AND BATTERIES IN SERIES)

The magneto performs three (3) functions simultaneously;
i) The electrically powered magneto directly charges the Starter Battery that supplies power to the simple Electric Motor in the cycle that is (Magneto-to-Starter Battery-to-Electric Motor) continuously.
ii) The electrically powered magneto(s) powers the Load (multi-engines), then Load to Starter Battery and then the Starter Battery in turn feeds the Electric controlled Motor. Alternatively, the magneto(s) directly powers the Load, which in turn directly routed feeds the Electric Motor. The Starter battery powers the system and/or serves for redundancy purpose after starting the process.
iii) The magneto(s) simultaneously charges the main battery/back-up batteries, which then feeds power to the Load. The load then feeds the starter battery and which in turn feeds the electric motor. Alternatively, the magneto directly powers the simple electric motor.
These three (3) cycles represented in the mechanical-electrical system are all representations in a complete self-powering structure including redundancy.
Note: The applicability of the wiring system, battery/capacitor, transformer, converter, inverter, fuse, booster, voltage regulator and type of mechanical and electrical motors, (dynamo/magnetos) used are all dependent upon the parameter(s) of the energy need, and/or Load capacity. Extreme caution should be applied in a wiring system from the magneto to battery, and same from battery to the Load, while functioning simultaneously as battery management systems may differ in their functions and parameters of operations.

### ENERGY PRINCIPLE

This complete application of the energy cycle in this electro-mechanical system conveys the principle of the Law of Conservation of Energy which proves the concept that; [According to the Law of Conservation of Energy, energy is neither created nor destroyed. Rather, energy can only be converted from one form of energy to another form of energy].

Energy is the occurrence of a natural phenomenon, however, its end-product can be transformed and used in various forms. An innovative mechanical structure and an innovative application of the energy process involving; the transformation, conservation, and distribution of energy while producing electricity which is re-cycled for self-consumption within same mechanical structure and including a process of self-recharging of the power structure for continuous power operation is unique. That is the application of this complete energy cycle process, and this electrical power cycle process implemented within same machine structure uninterrupted is new. This complete mechanical structure, and this complete application of the energy cycle process, and this complete power distribution process within the same mechanical structure in a functioning operational system will have as nomenclature (Ma'ah-ncho'oh Mundingo Donald Ghogomu's Complete Mechanical-Electrical Energy Cycle Process and System)., abbreviation (MMDG) initialed (M²DG)=The Complete Mechanical-Electrical Energy Cycle Process and System). This complete energy structure can be mathematically summarized as;

[Mechanical Energy=Electrical Energy], a [Mechanical Power=Electrical Power] all Re-Cycled for same Mechanical Structure Energy, and same Power for Self-Consumption and Self-Recharging Units (energy unit, power unit, charging unit, and recharging unit). This entire machine structure and the energy application, re-cycling and functioning processes are unique. Indefinite operation.
Thus, the application of this [New] Complete Mechanical-Electrical Energy Cycle Process and System (M²DG) implemented with this Mechanical Structure can be Expressed and Mathematically analyzed as; Mechanical Energy (M.nrg)≅Electrical Energy (E.nrg), because Mechanical Energy Produced is directly proportional to Electrical Energy Produced; That is (i.e), [M(nrg) produced∝E(nrg) produced].
A similar Relationship Expression Analysis; Mechanical Power (M.p)≅Electrical Power (E.p), because Mechanical Power produced is directly proportional to Electrical Power produced; i.e [M(p) produced∝Electrical Power produced E(p)].
Applying both Energy (nrg) and Power (p) Relationships; implies the cycle of the Mechanical and Electrical Energy approximately equals the cycle of the Mechanical and Electrical Power. That is the Product; [M(nrg)×E(nrg)]≅[M(p)×E(P)].

### ELECTRIC MOTOR(S)

This invention solves the unsatiable quest/need for energy, thus making it easy and affordable universally. This invention involves the use of electrical motors. These electrical motor generators are attached in series (Alternator and Dynamo) generating Alternating Current (AC) and Direct Current (DC) simultaneously; while with the Dynamo/Magneto system attached separately, generates Direct Current (DC) only. Simple electric motors (engine) are incorporated in the system for control, sustenance, efficient, and safe power control. In the Science of Physics, a “dynamo” is a machine for converting mechanical energy into electrical energy; definition (a generator). A generator can provide Alternating Current (AC), or Direct Current (DC). Permanent magnet DC Motor(s) is a preferable choice for this type of energy and electricity power production, for which its power, efficiency and sustainability will last longer periods during heavy operations, and the armature's lifespan is longer. Series, Shunt, and Compound DC Motors are examples of permanent magnet DC type motors that are applicable depending on the purpose or need. In modern times, generators manufactured do not self-operate without an external power energy source. Known energysources for powerproduction are; fuel to operate the internal engine for combustion, external solar energy, hydro-electric power, nuclear power, turbine wind power, or turbine engines powered by gas for electricity production; however, the generator still relies, or depends on all these external energy and power sources to power/operate the generator's engine and enabling it to function. Thus, producing electricity power needed for consumption and distribution at micro or macro scales. A Self-energy electricity producing, transforming, and Self-charging (generator) mechanism powering “itself” without external power/force, or fuel source(s) during operation had not been conceptualized till now, and thus, this type of complete Electric generator of Electro-mechanical cycles and self-charging structural system is now manufactured. This electric generator is a unique system of the energy cycles, self-electricity power production, and self-consumption which revolutionizes how Energy is readily re-routed and used, transformed, conserved, and easily “self” applied, consumed and distributed within the same system. While a “dynamo” or a machine for converting mechanical energy into electrical energy can be used, a successful mechanical and electrical motor system coupled together in a motion system can be best achieved by the integration of a controlled electric motor to achieve a better energy/power output. Thus, the speed of the controlled electric motor produced is directly proportional to the energy/power output in a controlled and sustained electro-mechanical system in motion. My invention involves electric motor(s) connected in single and/or series formation. The electric motors (generators) connected in series increases the desired output, power, performance, or results. However, the application of power boosters such as converters, transformers, or inventers applied in the circuit, enhances performance for desired results as needed for Load Capacity. Batteries with Battery Management Systems (BMS) with connections both in series and/or parallel, functioning simultaneously for power and/or voltage outputs within same operating system is feasible, while charging battery/batteries with a safe circuit connection either in parallel or series. Faulty BMS can produce negative outcomes/results. Monitoring of the circuit system connection during battery charging operation is highly recommended.

### CONCLUSION

The Omni-Electric Generator is a Self-Sustaining All Electric Generator, which is Self-Powered, Self-Charging and Self-Re-Charging, and at same time continuously powers a load without any external energy source incorporated to it. This Omni-Electric Generator has a system of fundamentally integrated components for self-energy production and consumption, conversion, transformation, self-charging, and output/distribution for domestic and commercial purposes, and for both small- and large-scale energy needs. However, some variables and other factors may apply depending on the type of powered electric motor, the capacity and type of dynamo (alternator/magneto) to be used in the process of electricity/energy production, transformation, distribution, and the operational cycle. For example, the power produced by the simple electric motor coupled to the dynamo is directly proportional to the electricity generated by the dynamo motor. These are primary factors for consideration. Thus, this affects the total energy and power for the electricity (current) produced. The voltage, rate of charge of the capacitor/battery, the total energy cycle, and the distribution and redistribution of the electricity within the system is dependent upon each of these secondary factors. The basic diagram(s) are examples that can be varied accordingly to satisfy the manufacturing parameter(s), application and consumption needs of the consumers. While it is possible to power a load and charge same battery simultaneously, extreme caution should be considered in the operation of the entire structure as battery management systems are different and appliance/material/battery failure may occur due to heat or structural malfunction. Though mechanical electric motors such as alternators and magnetos can self-start the process of generating mechanical energy, the use of a capacitor/battery controlled electric motor here attached with the alternator/dynamo/magneto in this invention is for a controlled energy operation, convenience, efficiency, sustainability, with safe operation and desired output. The scientific aspect of generating the energy , transformation of the energy, and the distribution of the energy (end product) for electric power consumption is experimentally supported by the end result of its energy production and the reapplication of the same electricity power and total energy produced within same mechanical system; that is, the simultaneous production of the mechanical energy to electrical energy, recycling and redistribution of the electric power produced within the same mechanical system for “self” consumption, that is powering and charging its own engine in operation—is a positive result. This engineering invention/concept is adaptable for power production and self-consumption purposes in a vast majority of products included but not limited to all vehicle types (motor bikes, cars, trains, boats, aircraft), domestic, and for huge commercial consumption. The applicability of the Omni-Electric Generator is feasible and universal.

1: The Omni-Electric Generator is a Self-Sustaining All Electric Generator, which is Self-Powered, Self-Charging and Self-Re-Charging, and at same time continuously powers a load without any external energy source or feed incorporated to it: (normal ordinary generators available before this invention, use other energies from nuclear, wind, hydro-energy, solar, propane, natural gas, diesel or some other fuel, or any type of external energy to feed and run the generators which in turn convert such into electricity to give energy that powers a load. In this invention (the Omni-Electric Generator), energy produced is controlled, and it is completely SELF-SUSTAINING in all ramifications.

2: The Omni-Electric Generator is an Integration Process and System (Omni Electrical Process and System) of electric motors, in combination within an electric circuit system constituting an All-Electrical Circuit of electricity for continuous energy flow, cycling Mechanical to Electrical Energy, and Electrical Energy to Mechanical Energy. Thus, generating power within an All-Electrical Circuit System of Self-Production, Self-Charging, Self-Recharging, Self-Consumption, and Self-Distribution of electricity within the same system and for external usage; this process is called the Omni-Electric Generator Process and System of Complete Electrical Energy Flow-Cycle, or in short, the Omni Electrical Process and System (CEPS).

3: This invention (OEG) can be Structured in two ways;
i) As a Dual integration system, integrating both Alternating Current (AC) and Direct Current (DC) Electric Generators/Dynamo motors combined in series and which are then attached to an electric motor engine within the system of operation. OR,
ii) Single integration system which integrates either a single Alternating Current (AC), or a single Direct Current (DC) Generator Motor, this system attached to an electric motor engine controlled within the system of operation.
KEY WORDS: Process and System of Electric Generator Motors (AC/DC), Simple Electric Motor Engine(s), Self-Sustaining, Self-Start (with or without battery), Self-Charging, Self-Recharging, Controlled Energy/Power, Continuous Generation and Continuous flow of electricity/power for Load.

4: The Omni-Electric Generator has the ability of converting the same mechanical energy to electrical energy and vice versa (mechanical power to electrical power, and vice versa), generating electrical power, transforming the energy, redistributing the energy supplied, and continuously operating the machine while self-charging (it-self) for long, or extended periods/time, thus supplying electricity for self-operation, self-consumption and distribution.

5: This Self-Powered Electro-mechanical device (the Omni-Electric Generator) produces electricity within the cycle which is initiated manually/mechanically, or by a starter battery (chemical energy/electro-chemical energy within the battery cells) to store charges and electrical energy as the source of its internal power initiator. This initiation mechanically or from the battery (chemical energy) in-turn activates the electromagnetic processes in the dynamo, alternator, and/or magneto. These processes are summarized thus;
i) The initial battery powers the controlled DC electric motor-engine, which then powers the attached dynamo/magneto with the electric motor engine generating current flow boosted and supplied to the load integrated with battery management systems for power/energy control and safety applications. This unique type of generator has unlimited capabilities and applications.
ii) Initiating battery powers Dynamo/Alternator/Magneto which produces electricity, which is converted to AC or DC power with appropriate booster/converter/inverter with integrated (fuse(s) and/or voltage regulator) that feeds the load.
iii) A simple battery powered DC electric motor-engine, attached/connected with a magneto/dynamo and connected with a Pulse Width Modulation (PWM) Motor Control System which controls speed of the magneto/dynamo to power the entire electrical system via a booster/converter/Inverter in a complete energy cycle. This unique system of boosting Direct Current (DC) in a Mechanical to Electrical Energy Cycling Process has unlimited applications with the use of a battery/capacitor for self-charging, recharging, and distribution of energy.
iv) Mechanical/manual initiation of the Dynamo, Alternator, or Magneto which then produces electricity which is either converted to DC (e.g vehicle use) or AC (e.g home use) depending on application need with appropriate converter/inverter (current and/or voltage regulator to power the load.
v) A battery powered DC electric motor engine is connected/attached with the dynamo/magneto, both integrated sub-systems controlled via the vehicle's speed control system, during operation the dynamo/magneto will generate boosted current, or electricity power directly powering the entire vehicle's electrical system in a complete recycled energy system.

6: A controlled electric motor integrated within the electric motion system/circuit is recommended for a controlled and sustained power (energy) output within the entire system. The Speed of the Electric Motor is directly proportional to the Power (Energy) produced. (Speed affects Power/Energy Output). Example, for an electric vehicle integrated with electrically controlled dynamo, the speed generated approximately equals the power/electrical energy output. Speed of Electric Motor/Velocity Traveled is directly proportional to the Power Output/Total Energy Produced. [Speed of Motor/Velocity Traveled@given Time≅Power Output/Total Energy].
However, Energy Production [E.P] and Energy Transformation [E.T] can directly and variably depend upon certain factors as Power is produced, Current, Voltage, RPM of Motor(s) affecting Speed and capacitor/battery-Rate of Charge. Example, the faster the electrical motor spins, the faster the battery/capacitor rate of charge increases during a short period/time.

7: The Alternator Generator when applied (Generates Alternating Current—AC), and (AC Recharges Battery) and the converted energy from the system powers the load. When the Magneto Generator is applied (Generates Direct Current—DC), the DC directly powers the Load, and/or recharges the battery acting as a back-up) and vice versa. The Direct Current (DC), directly powers the Dynamo (if applicable), or directly powers Load. It is a duo system of (two electric motors) when a magneto generator is directly applied. When coupled and electrically controlled, the alternator motor is also used to provide mechanical energy for the magneto rotor to spin about its horizontal axis, thus enabling the magneto to convert mechanical energy to electrical energy.

8: By means of mechanical attachment, in series or parallel, the electric motor is attached to the mechanical energy producing motor (dynamo motor). Or, Load is directly attached to the electrical energy producing motor (magneto). By use of mechanical and electrical components (gears, pinions, rotary belts/chains, switches, fuses, diodes, transformers, capacitors/batteries, connectors, and electrical wirings) this process of energy production and conversion of mechanical energy to electrical energy for the system's operation including self-charging and energy redistribution is attained, and the mechanical energy is transformed into electrical power for continuous operation of the same device/machine, and while supplying/distributing energy to other devices for consumption is unique. This is attained minus—external power source(s) applied, or use of fuel source(s), or solar energy source(s). Example, this structural internal system of energy production, self-consumption, and recycling method can produce continuous power non-stop without external power for charging, power and recycling, and it is infinite, except there is structural failure, or a component failure, or routine maintenance servicing required. This is unique!

9: The vehicle's accelerator/throttle system is connected to the electric motor-engine's speed control system, and with a dynamo/magneto attached to the system, the accelerator/throttle speed controls the power output of the generator to the entire vehicle's electrical system; Or; A battery powered simple DC motor-engine is attached with the magneto/dynamo and connected with a Pulse Width Modulation (PWM) Motor Control System controlling speed of the attached magneto/dynamo's power output to the electrical system; Or; An integrated electronic control switch with the magneto/dynamo functioning system and incorporated with the battery capacitor, activates and self-powers the mechanical operation.

10: [Mechanical Energy=Electrical Energy], directly proportional (a) to [Mechanical Power=Electrical Power] all Re-Cycled for same Mechanical Structure Energy, and same Power for Self-Consumption and Self-Recharging Units (energy unit, power unit, charging unit, and recharging unit). This entire machine structure and the energy application, re-cycling and functioning processes, uninterrupted are unique. An indefinite operation, except for a component or structural failure, or maintenance issue.
This complete mechanical structure, and this application of the complete energy cycle process, and this complete power distribution process within the same mechanical structure in a functioning operational system will have as nomenclature (Ma'ah-ncho'oh Mundingo Donald Ghogomu's Complete Mechanical-Electrical Energy Cycle Process and System), abbreviation
